(19) United States
(12) Patent Application Publication
(10) Pub. No.: US 2021/0407310 A1
(43) Pub. Date: Dec. 30, 2021

(54) TEACHING AND LEARNING PLATFORM

(71) Applicant: Kamaria Finch, Atlanta, GA (US)

(72) Inventor: Kamaria Finch, Atlanta, GA (US)

(21) Appl. No.: 17/358,799

(22) Filed: Jun. 25, 2021

Related U.S. Application Data
(60) Provisional application No. 63/043,905, filed on Jun. 25, 2020.
(60) Provisional application No. 63/214,944, filed on Jun. 25, 2021.

(51) Int. Cl. G09B 5/14; G06N 20/00; G09B 5/06; G09B 7/02; G06F 40/40

(52) U.S. Cl. CPC G09B 5/14; G06N 20/00; G06F 40/40; G09B 7/02; G09B 5/065

(57) ABSTRACT

In one aspect, the present disclosure relates to a teaching platform comprising: an administrator hardware module comprising an Administrator User Interface (AUI) configured to allow an administrator user to operate the following: a profile module comprising: at least one administrator profile, and at least one class profile, a teaching application module comprising: a curriculum, a testing module, and a scheduler, and an artificial intelligence teacher module configured to operate the AUI upon the absence of an administrator user; and at least one student hardware module comprising a Student User Interface configured to allow a student user to operate the following: a learning application module comprising: a plurality of learning materials, a plurality of study materials, and a plurality of testing materials, a virtual tutor configured for virtual tutoring of the student user, and a communications module configured for communication between the at least one student user and the administrator user.

### RELATED APPLICATION

This application claims the benefit of priority to U.S. Application No. 63/043,905 filed Jun. 25, 2020, and U.S. Application No. 63/214,944 filed Jun. 25, 2021, which are hereby incorporated by reference herein in its entirety.

It is intended that the above-referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to Virtual Teaching and Learning.

### BACKGROUND

In some situations, teaching in in-person classrooms are unable to happen. For example, during a pandemic, an infectious disease may force the majority of the population to stay at home, including from school. Further examples such as cyber school, students who are sick for extended periods of time, and international students may require remote learning. Thus, the conventional strategy is to have makeshift virtual classrooms via existing virtual meeting platforms such as WebEx, Zoom, and Google Hangouts. This often causes problems because the conventional strategy does not have many of the features needed to properly teach, administer assignments, take quizzes and tests, and detect when students deviate from their classwork. An all in one platform that integrates all necessary tools to teach and learn is needed.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In accordance with the purposes of the present disclosure, as embodied and broadly described herein, in one aspect, relates to an all-in one in-class or remote teaching platform.

In one aspect, the present disclosure relates to a teaching platform comprising: an administrator hardware module comprising an administrator-facing memory storage coupled to an administrator-facing processing unit, the administrator processing unit comprising an Administrator User Interface (AUI) configured to allow an administrator user to operate the following: a profile module comprising: at least one administrator profile, and at least one class profile, a student hardware operative connectivity module configured to provide operative communication between the administrator hardware module and a student hardware module, a teaching application module comprising: a curriculum, a testing module, and a scheduler, and an artificial intelligence (“AI”) teacher module configured to operate the AUI upon the absence of an administrator user; and at least one student hardware module comprising a student-facing memory storage coupled to a student-facing processing unit, the student-facing processing unit comprising a Student User Interface (SUI) configured to allow a student user to operate the following: a learning application module comprising: a plurality of learning materials, a plurality of study materials, and a plurality of testing materials, a virtual tutor module configured for virtual tutoring of the student user, and a communications module configured to allow communication between the at least one student user and the administrator user.

In another aspect, the present disclosure relates to a method for operating a teaching and learning platform, the method comprising: operatively connecting an administrator hardware module to at least one student hardware module; operating, via an Administrator User Interface (AUI), the administrator software module, the operating comprising: accessing, in accordance with a unique identification of an administrator user, a profile module, the profile module comprising: at least one administrator profile, and at least one class profile, retrieving, via a teaching application module, the following: a curriculum comprising a plurality of lesson plans, a testing module, and a scheduler, presenting, to at least one student user via a Student User Interface (SUI), contents of one of the plurality of lesson plans, tracking a level of attention of the at least one student the during the presenting, restricting, via the testing module, at least one operational ability of the SUI, administering, via the testing module, at least one testing material to the student user, the student user being operative to conduct the at least one testing material via the SUI, tracking a plurality of inputs of the student user, grading, upon completion and submission of the testing material by the student user, the at least one testing material, and generating a report of the graded at least one testing material.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure; and

FIG. 2 illustrates a computing device 200.

FIG. 4 illustrates a method 4000 for operating a teaching and learning platform;

FIG. 5 illustrates a method 5000 for providing reports on students, classes, teachers, and/or schools;

FIG. 6 illustrates a method 6000 for administering testing;

FIG. 7 illustrates a method 7000 for tracking student attention;

FIG. 8 illustrates a method 8000 for facilitating a virtual lecture; and

FIG. 9 illustrates a method 9000 for limiting device data collection.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of a teaching platform, embodiments of the present disclosure are not limited to use only in this context.

I. Technical Advantages

The software and hardware may be twofold in its usefulness to teachers and/or instructors. In some embodiments, the teaching and learning platform may combine all teacher needs in one software system with easy to use applications and system processes. In further embodiments, the teaching and learning platform may provide an administrator hardware module comprising a teaching software module that may connect to all student software and may monitor, disseminate, test, set pacing, goal setting, testing, and more for a plurality of students. In yet further embodiments, the teaching and learning platform may take the place of a teacher's need to:
Remember daily goals, lesson plan steps
Have students wait to move forward when a teacher is occupied with one or more students
Multi-task inefficiently and with much more ease
Mentally remember each item on the agenda (software has recorded the information and is accessible to the teacher at any time)
Monitor each individual student
Have a separate tutor
Have a risk of losing paperwork and information.

II. Platform Overview

This overview is not intended to identify key features or essential features of the claimed subject matter. Nor is this overview intended to be used to limit the claimed subject matter's scope.

Embodiments of the present disclosure may comprise methods, systems, and a computer readable medium comprising, but not limited to, at least one of the following:
A. An Administrator Hardware Module 300;
B. A Student Hardware Module 400; and

In some embodiments, the present disclosure may provide an additional set of components for further facilitating the system. The additional set of components may comprise, but not be limited to:
C. A Cloud Computing and Processing Module 500.

Details with regards to each module is provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each component disclosed within each module can be considered independently without the context of the other components within the same module or different modules. Each component may contain language defined in other portions of this specifications. Each component disclosed for one module may be mixed with the functionality of another module. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, at least one computing device 200 may be employed in the performance of some or all of the stages disclosed with regard to the methods. Similarly, an apparatus may be employed in the performance of some or all of the stages of the methods. As such, the apparatus may comprise at least those architectural components as found in computing device 200.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the modules disclosed herein. The method may be embodied as, for example, but not limited to, computer instructions, which when executed, perform the method. The method may comprise the following stages:
operatively connecting an administrator hardware module to at least one student hardware module;
operating, via an Administrator User Interface (AUI), the administrator software module, the operating comprising:
   accessing, in accordance with a unique identification of an administrator user, a profile module, the profile module comprising:
      at least one administrator profile, and
      at least one class profile,
   retrieving, via a teaching application module, the following:
      a curriculum comprising a plurality of lesson plans,
      a testing module, and
      a scheduler,
   presenting, to at least one student user via a Student User Interface (SUI), contents of one of the plurality of lesson plans,
   tracking a level of attention of the at least one student the during the presenting,
   restricting, via the testing module, at least one operational ability of the SUI,
   administering, via the testing module, at least one testing material to the student user, the student user being operative to conduct the at least one testing material via the SUI,
   tracking a plurality of inputs of the student user,
   grading, upon completion and submission of the testing material by the student user, the at least one testing material, and
   generating a report of the graded at least one testing material.

Although the aforementioned method has been described to be performed by the platform 100, it should be understood that computing device 200 may be used to perform the various stages of the method. Furthermore, in some embodiments, different operations may be performed by different networked elements in operative communication with computing device 200. For example, a plurality of computing devices may be employed in the performance of some or all of the stages in the aforementioned method. Moreover, a plurality of computing devices may be configured much like a single computing device 200. Similarly, an apparatus may be employed in the performance of some or all stages in the method. The apparatus may also be configured much like computing device 200.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

An administrator hardware module may be provided. In some embodiments, the administrator hardware module may comprise a teaching software module. In further embodiments, the administrator module may comprise an administrator input module. In yet further embodiments, the administrator hardware module may comprise a computing device.

A student hardware module may be provided. In some embodiments, the student hardware module may comprise a student software module. In further embodiments, the student hardware module may comprise a student input module. In yet further embodiments, the student hardware module may comprise a computing device.

III. Platform Configuration

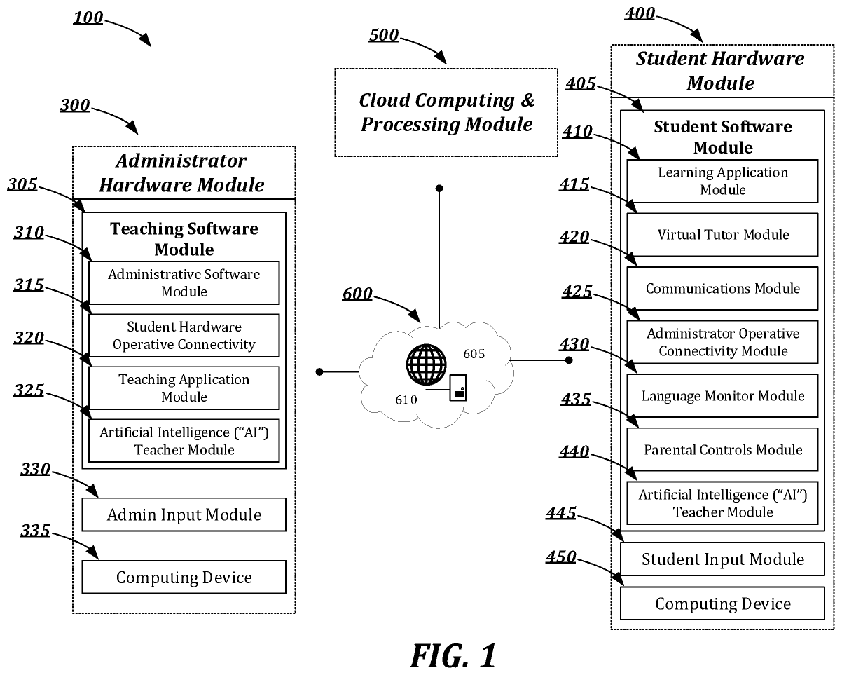

FIG. 1 illustrates one possible operating environment through which a platform consistent with embodiments of the present disclosure may be provided. By way of non-limiting example, a teaching platform 100 may be hosted on, for example, a cloud computing service. In some embodiments, the platform 100 may be hosted on a computing device 200. A user may access platform 100 through a software application and/or hardware device. The software application may be embodied as, for example, but not be limited to, a website, a web application, a desktop application, and a mobile application compatible with the computing device 200. One possible embodiment of the software application and/or hardware device may be provided by the AWS suite of products and services provided by Amazon Inc.

FIG. 1 illustrates one possible operating environment through which a platform consistent with embodiments of the present disclosure may be provided. By way of non-limiting example, a platform 100 for providing the methods and systems for may be hosted in both a blockchain protocol (“on-chain”) and off of a blockchain protocol (“off-chain”). One possible embodiment of the platform may be provided by the Hyperledger protocol provided by Linux Foundation. It should be understood that layers and stages performed by the layers may be either “on-chain” or “off-chain.” The present disclosure anticipates embodiments with variations as to which stages may be performed “on-chain” or “off-chain.”

Accordingly, embodiments of the present disclosure provide a software and hardware platform comprised of a distributed set of computing elements, including, but not limited to:

A. Administrator Hardware Module 300

FIG. 1 illustrates administrator hardware module 300 consistent with an embodiment of the disclosure. In some embodiments, the administrator hardware module may comprise a teaching software module. In further embodiments, the administrator hardware module 300 may comprise an administrator input module 330. In yet further embodiments, the administrator hardware module 300 may comprise a display module. In even further embodiments, the administrator hardware module 300 may comprise a computing device.

In even further embodiments, the administrator hardware module 300 may be accessed via a User Interface (UI) 600, and/or an Administrator User Interface (AUI) 605.

a. Teaching Software Module 305

A teaching software module 305 may be provided. In some embodiments, the teaching software module 305 may comprise an administrator software module 310. In further embodiments, the teaching software module 305 may comprise a student hardware operative connectivity module 315. In even further embodiments, the administrator software module 310 may comprise a teaching application module 320. In even still further embodiments, the administrator software module 310 may comprise an AI teacher module 325.

i. Administrator Software Module 310

An administrator software module 310 may be provided. In some embodiments, the administrator software module 310 may comprise at least one administrator profile module. The at least one administrator profile module may be used to provide unique settings, user interface, and/or controls for each administrator profile.

In some embodiments, the administrator software module 310 may comprise at least one class profile module. In some embodiments, the at least one class profile module may comprise at least one of the following: a listing of personal information of each of the at least one student user, saved content specific to a class, and saved content specific to the at least one student user. The at least one class profile module may be used to provide corresponding lesson plans, class lists, and/or saved content specific to a class.

In some embodiments, the administrator software module 310 may comprise a reporting module. The reporting module may be used to generate progress, grades, comparisons, individual student analysis, and behavioral reports of students.

ii. Student Hardware Operative Connectivity Module 315

A student hardware operative connectivity module 315 may be provided. In some embodiments, the student hardware operative connectivity module 315 may comprise a connectivity means. The connectivity means may be used for information transfer to and from at least one student hardware module 400 and the administrator hardware module 300. In further embodiments, the connectivity means may comprise Wi-Fi, Bluetooth, Near Field Communication (NFC), Internet Protocol (IP) communications techniques, or access to external wiring.

In some embodiments, the student hardware operative connectivity module 315 may comprise a plurality of student hardware module screen and/or device controls. The plurality of student hardware module screen and/or device controls may be used for manipulating a at least one student hardware module's screen to close out of unwanted viewing content and/or to progress pages in a virtual textbook.

In some embodiments, the student hardware operative connectivity module 315 may comprise a plurality of student hardware module screen and/or device monitoring controls. In this way, the plurality of student hardware module screen and/or device monitoring controls may be used to view activity on at least one student hardware module 400.

In some embodiments, the student hardware operative connectivity module 315 may comprise an administrator notification module. The administrator notification module may be used for automatic notification of a student hardware module 400 lagging behind the projected pace of a lesson plan, or the deviation of researching from a designated topic.

In some embodiments, the student hardware operative connectivity module 315 may comprise a monitoring module. In some embodiments, the monitoring mode may comprise a keystroke monitor. The keystroke monitor may be used for tracking student's typing during examination. In further embodiments, the monitoring mode may comprise a copying and/or pasting detection. The copying and/or pasting detection may be used for detecting cheating and/or plagiarism. In even further embodiments, the monitoring module may comprise a location tracking relative to other devices. The location tracking relative to other devices may be used for determining whether student's may be in each other's presence thereby cheating by assisting one another during testing. In still further embodiments, the monitoring mode may comprise a test monitoring module. In some embodiments, the test monitoring module may comprise a biometric detection. The biometric detection may be used for positive identification prior to beginning a test.

iii. Teaching Application Module 200

A teaching application module 320 may be provided. In some embodiments, the teaching application module 320 may comprise a plurality of lesson plans. The plurality of lesson plans may be used for organization of teaching material. The plurality of lesson plans may further be used to generate study materials such as notes, assignments, homework, and the like. In some embodiments, the plurality of lesson plans may comprise a plurality of lesson plan templates. The plurality of lesson plan templates may be used to streamline creation of the plurality of lesson plans. In further embodiments, the plurality of lesson plans may comprise at least one checklist. The at least one checklist may be used for progressing through the plurality of lesson plans.

In some embodiments, the teaching application module 320 may comprise a scheduler. The scheduler may be used for creating appointments, meetings, and the like with teachers, parents, and/or students.

In some embodiments, the teaching application module 320 may comprise a calendar. The calendar may be used for reference to key dates and deadlines.

In some embodiments, the teaching application module 320 may comprise a curriculum. The curriculum may be used for compiling a plurality of lesson plans in an organized fashion.

In some embodiments, the teaching application module 320 may comprise a plurality of statewide standards. The plurality of statewide standards may be used to adhere to, and compare students with, the educational standards mandated by each state. The plurality of nationwide standards may be embodied as, but not limited to, government-regulated standard, nationwide standards, and local standards.

In some embodiments, the teaching application module 320 may comprise a testing module. In some embodiments, the testing module may comprise a plurality of testing materials. The plurality of testing material may comprise a plurality of benchmark tests. The plurality of benchmark tests may be used as a point of reference to demonstrate where students are at individually. In further embodiments, the testing module may comprise a plurality of statewide exams. The plurality of statewide exams may be used for schools to receive federal funding. In further embodiments, the testing module may comprise a scanner. The scanner may be used to record, tabulate, and/or collect the plurality of testing materials once taken and/or completed by a student. In yet further embodiments, the testing module may comprise a grading module. The grading module may be used to grade the plurality of testing materials. The grading module may also be used to mark, make a record of, and/or notify the professor of unidentifiable text, unrecognizable font, or foreign format. In some embodiments, the grading module may comprise Natural Language Processing (NLP). In some embodiments, the grading module may comprise Optical Character Recognition (OCR).

In some embodiments, the teaching application module 320 may comprise a plurality of state and nationwide academic standards. The plurality of state and nationwide standards may be used to adhere to, and compare students with, the standards set by programs such as “Common Core.” In some embodiments, the plurality of state and nationwide standards may comprise a plurality of teacher metrics. The plurality of teacher metrics may be used to compare teacher's performance, grades, and the like to other teachers. The plurality of teacher metrics may be further used to compare teachers by school, by county, by state, or nationwide. In some embodiments, the plurality of state and nationwide academic standards may comprise an auto reporting scores to state or nationwide databases. The auto reporting scores to state or nationwide databases may provide a streamlined approach to aggregating the required testing scores.

In some embodiments, the teaching application module 320 may comprise a timer. The timer may be used for keeping track of time for assignments, testing, and the plurality of lesson plans.

In some embodiments, the teaching application module 320 may comprise a parent call capability. The parent call capability may be used for contacting a student's parents for student behavioral issues, or in case of emergencies.

In some embodiments, the teaching application module 320 may comprise an attention monitoring module. The attention monitoring module may appear when it is determined that a student is distracted. The attention monitoring module may further provide a notification to a student to encourage the student to focus. The attention monitoring module may further provide a notification to a teacher informing the teacher of the distracted student. In some embodiments, the attention monitoring module may comprise an eye tracking module. The eye tracking module may be used to collect eye movement data to determine if a student is distracted. In some embodiments, the attention monitoring module may comprise a face movement tracking module. The face movement tracking module may collect face movement data to determine if a student is distracted.

iv. AI Teacher Module 325

An AI teacher module 325 may be provided. In some embodiments, the AI teacher module 325 may comprise a curriculum instruction module. The curriculum instruction module may be used for progressing a lesson plan without a physical teacher present.

In some embodiments, the AI teacher module 325 may comprise a classwork monitoring module. The classwork monitoring option may be used for ensuring a student is on task.

In some embodiments, the AI teacher module 325 may comprise a task time monitoring module. The task time monitoring option may be used for ensuring a student spends an appropriate amount of time on a task.

In some embodiments, the AI teacher module 325 may comprise a task accuracy module. The task accuracy module may be used for analyzing the accuracy of completed tasks by students.

In some embodiments, the AI teacher module 325 may comprise a teaching software control module. The administrator software control module may be used to utilize any feature the teaching software module 305 comprises.

In some embodiments, the AI teacher module 325 may comprise a pattern tracking module. The pattern tracking module may be used for tracking student behaviors and/or student patterns. The pattern tracking module may be further used for providing customized homework, class work, assignments, testing materials, and the like to accommodate a student's progression and/or understanding of the lesson plan.

In some embodiments, the AI teacher module 325 may comprise an audible reading module. In some embodiments, the audible reading module may comprise Natural Language Processing (NLP). In some embodiments, the audible reading module may comprise Optical Character Recognition (OCR). The audible reading module may be used to read out loud any material or lesson plan normally read out loud by the teacher.

In some embodiments, the AI teacher module 325 may be hosted and/or reside on a cloud computing and processing module.

b. Administrator Input Module 330

An administrator input module 330 may be provided. In some embodiments, the administrator input module 330 may comprise a virtual keyboard. The virtual keyboard may be located on a display of the student hardware module 400. In some embodiments, the administrator input module 330 may comprise a detachable keyboard. The virtual and/or detachable keyboard may be used for operating the student hardware module 400 and/or the student software module. In some embodiments, the administrator input module 330 may comprise a stylus. The stylus may be used for operating the administrator hardware module and/or the teaching software module.

c. Display Module

A display module may be provided. In some embodiments, the display module may comprise at least one display. In further embodiments, the display module may comprise at least one screen.

d. Computing Device 335

A computing device 335 may be provided. The computing device 335 may be embodied as, at least in part, for example, computing device 200.

B. Student Hardware Module 400

FIG. 1 illustrates student hardware module 400 consistent with an embodiment of the disclosure. In some embodiments, the student hardware module 400 may comprise a student software module. In further embodiments, the student hardware module 400 may comprise a student input module. In yet further embodiments, the student hardware module 400 may comprise a display module. In even further embodiments, the student hardware module 400 may comprise a computing device.

In even further embodiments, the student hardware module 400 may be accessed via a User Interface (UI) 600, and/or a Student User Interface (AUI) 610.

a. Student Software Module 405

A student software module 405 may be provided. In some embodiments, the student software module 405 may comprise a virtual tutor module. In further embodiments, the student software module 405 may comprise a learning application module 410. In yet further embodiments, the student software module 405 may comprise a communications module. In still further embodiments, the student software module 405 may comprise a language monitor module. In even further embodiments, the student software module 405 may comprise an administrator hardware operative connectivity module 425. In yet still further embodiments, the student software module 405 may comprise a parental controls module. In even still further embodiments, the student software module 405 may comprise a student-facing AI teacher module 440.

i. Virtual Tutor Module 415

A virtual tutor module 415 may be provided. In some embodiments, the virtual tutor module 415 may comprise a video streaming module. The video streaming module may be used to for virtual face-to-face tutoring.

In some embodiments, the virtual tutor module 415 may comprise a screen sharing module. The screen sharing module may be used to assist in tutoring the student. In further some embodiments, the virtual tutor module 415 may be utilized and/or actuated by the student facing-AI teacher module 325 and/or the AI teacher module 440.

ii. Learning Application Module 410

A learning application module 410 may be provided. In some embodiments, the learning application module 410 may comprise a plurality of lesson plans. The lesson plans may be used for organization of teaching material. The plurality of lesson plans may further be used to provide study materials such as notes, assignments, homework, and the like. In some embodiments, the lesson plans may comprise a plurality of lesson plan templates. The lesson plan templates may be used to streamline creation of the plurality of lesson plans. In further embodiments, the plurality of lesson plans may comprise at least one checklist. The checklist may be used for progressing through the plurality of lesson plans.

In some embodiments, the learning application module 410 may comprise a scheduler. The scheduler may be used for creating appointments, meetings, and the like with teachers, parents, and/or students.

In some embodiments, the learning application module 410 may comprise a calendar. The calendar may be used for reference to key dates and deadlines.

In some embodiments, the learning application module 410 may comprise a curriculum. The curriculum may be used for compiling a plurality of lesson plans in an organized fashion.

In some embodiments, the learning application module 410 may comprise a plurality of statewide standards. The plurality of nationwide standards may be used to adhere to, and compare students with, the educational standards mandated by each state. In some embodiments, the teaching application module 320 may comprise a testing module. In some embodiments, the testing module may comprise a plurality of testing materials. The plurality of testing material may comprise a plurality of benchmark tests. The plurality of benchmark tests may be used as a point of reference to demonstrate where students are at individually. In further embodiments, the testing module may comprise a plurality of statewide exams. The plurality of statewide exams may be used for schools to receive federal funding. In further embodiments, the testing module may comprise a scanner. The scanner may be used to record, tabulate, and/or collect the plurality of testing materials once taken and completed by a student. In yet further embodiments, the testing module may comprise a grading module. The grading module may be used to grade the plurality of testing materials. The grading module may also be used to mark, make a record of, and/or notify the professor of unidentifiable text, unrecognizable font, or foreign format. In some embodiments, the grading module may comprise Natural Language Processing (NLP). In some embodiments, the grading module may comprise Optical Character Recognition (OCR).

In some embodiments, the learning application module 410 may comprise a plurality of nationwide standards. The plurality of nationwide standards may be used to adhere to, and compare students with, the standards set by programs such as “Common Core.”

In some embodiments, the learning application module 410 may comprise a timer. The timer may be used for keeping track of time for assignments, testing, and the plurality of lesson plans.

In some embodiments, the learning application module 410 may comprise a parent call capability. The parent call capability may be used for contacting a student's parents for student behavioral issues, or in case of emergencies.

iii. Communications Module 420

A communications module 420 may be provided. In some embodiments, the communications module 420 may comprise an alert button module. The alert button module may notify a teacher that a student is in need of assistance.

In some embodiments, the communications module 420 may comprise a sound sensor.

In some embodiments, the communications module 420 may comprise a sound output.

iv. Language Monitor Module

A language monitor module may be provided. In some embodiments, the language monitor module may comprise NLP. The language monitor module may comprise a word restriction module. The word restriction module may prevent predetermined words or phrases to be successfully entered, transmitted, or communicated.

v. Administrator Hardware Operative Connectivity Module 425

An administrator hardware operative connectivity module 425 may be provided. In some embodiments, the administrator hardware operative connectivity module 425 may comprise a connectivity means. the connectivity means may be used for information transfer to and from at least one student hardware module 400. In further embodiments, the connectivity means may comprise Wi-Fi, Bluetooth, Near Field Communication (NFC), Internet Protocol (IP) communications techniques, or access to external wiring.

In some embodiments, the administrator hardware operative connectivity module 425 may comprise a plurality of student hardware module 400 screen controls. The plurality of student hardware module 400 screen controls may be used for manipulating at least one student hardware module 400's screen to close out of unwanted viewing content, or to progress pages in a virtual textbook.

In some embodiments, the administrator hardware operative connectivity module 425 may comprise a plurality of student hardware module 400 screen monitoring controls. In this way, the plurality of student hardware module 400 screen monitoring controls may be used to view activity on at least one student hardware module 400.

In some embodiments, the administrator hardware operative connectivity module 425 may comprise an administrator notification module. The administrator notification module may be used for automatic notification of a student hardware module 400 lagging behind the projected pace of a lesson plan, or the deviation of researching from a designated topic.

vi. Parental Controls Module 435

A parental controls module 435 may be provided. In some embodiments, the parental controls module 435 may comprise a plurality of privacy options. The plurality of privacy options may be used by the parents of a student to control the type and amount of data collected on their children.

vii. Student-Facing AI Teacher Module 440

A student-facing AI teacher module 440 may be provided. In some embodiments, the student-facing AI teacher module 440 may comprise a curriculum instruction module. The curriculum instruction module may be used for progressing a lesson plan without a physical teacher present.

In some embodiments, the student-facing AI teacher module 440 may comprise a classwork monitoring module. The classwork monitoring module may be used for ensuring a student is on task with their schoolwork.

In some embodiments, the student-facing AI teacher module 440 may comprise a task time monitoring module. The task time monitoring option may be used for ensuring a student spends an appropriate amount of time on a task.

In some embodiments, the student-facing AI teacher module 440 may comprise a task accuracy module. The task accuracy module may be used for analyzing the accuracy of completed tasks by students.

In some embodiments, the student-facing AI teacher module 440 may comprise an administrator software control module. The administrator software control module may use any feature the administrator software module 310 comprises.

In some embodiments, the student-facing AI teacher module 440 may comprise a pattern tracking module. The pattern tracking module may be used for tracking student behaviors and/or student patterns. The pattern tracking module may be further used for providing custom homework, class work, assignments, testing materials, and the like to where a student's progression and/or understanding of the lesson plan.

In some embodiments, the student-facing AI teacher module 440 may comprise an audible reading module. In some embodiments, the audible reading module may comprise Natural Language Processing (NLP). In some embodiments, the audible reading module may comprise Optical Character Recognition (OCR). The audible reading module may be used to read out loud any material or lesson plan normally read out loud by the teacher.

In some embodiments, the student-facing AI teacher module 440 may be hosted and/or reside on a cloud computing and processing module.

b. Student Input Module 445

A student input module 445 may be provided. In some embodiments, the student input module 445 may comprise a virtual keyboard. The virtual keyboard may be located on a display of the student hardware module 400. In some embodiments, the student input module 445 may comprise a detachable keyboard. The virtual keyboard and/or detachable keyboard may be used for operating the student hardware module 400 and/or the student software module 405. In some embodiments, the student input module 445 may comprise a stylus. The stylus may be used for operating the student hardware module 400 and/or the student software module 405.

c. Display Module

A display module may be provided. In some embodiments, the display module may comprise at least one display. In further embodiments, the display module may comprise at least one screen.

d. Computing Device 450

The computing device 450 may be provided. The computing device 450 may be embodied as, at least in part, for example, computing device 200.

C. Cloud Computing and Processing Module 500

FIG. 1 illustrates cloud computing and processing module 500 consistent with an embodiment of the disclosure. In some embodiments, a plurality of modules comprised in teaching platform 100 may be hosted on the cloud computing and processing module. In further embodiments cloud computing and processing module 500 may be embodied as, at least in part, for example, computing device 200.

III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, at least one computing device 200 may be employed in the performance of some or all of the stages disclosed with regard to the methods. Similarly, an apparatus may be employed in the performance of some or all of the stages of the methods. As such, the apparatus may comprise at least those architectural components as found in computing device 200.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

A. Method for Operating a Teaching and Learning Platform

Consistent with embodiments of the present disclosure, a method 3000 may be performed by at least one of the aforementioned modules. The method 3000 may be embodied as, for example, but not limited to, computer instructions, which when executed, perform the method 3000. The method 3000 may comprise the following stages:
operating, via an Administrator User Interface (AUI), the administrator software module, the operating comprising:
   3050—accessing, in accordance with a unique identification of an administrator user, a profile module, the profile module comprising;
      at least one administrator profile, and
      at least one class profile,
   3100—retrieving, via a teaching application module, the following:
      a curriculum comprising a plurality of lesson plans,
      a testing module, and
      a scheduler,
   3150—presenting, to at least one student user via a Student User Interface (SUI), contents of one of the plurality of lesson plans;
   3200—tracking a level of attention of the at least one student the during the presenting;
   3250—restricting, via the testing module, at least one operational ability of the SUI,
   3300—administering, via the testing module, at least one testing material to the student user, the student user being operative to conduct the at least one testing material via the SUI,
   3350—tracking a plurality of inputs of the student user,
   3400—grading, upon completion and submission of the testing material by the student user, the at least one testing material, and
   3450—generating a report of the graded at least one testing material.

A flow chart setting forth the general stages involved in a method consistent with an embodiment of the disclosure for providing teaching and learning platform 100 may be provided. Any disclosed method may be implemented using a computing device 200 or any other component associated with platform 100 as described in more detail below with respect to FIG. 3. For illustrative purposes alone, computing device 200 is described as one potential actor in the any of the stages.

B. Method for Providing Reports on Students, Classes, Teachers, and/or Schools

Consistent with embodiments of the present disclosure, a method 4000 may be performed by at least one of the aforementioned modules. The method 4000 may be embodied as, for example, but not limited to, computer instructions, which when executed, perform the method 4000. The method 4000 for providing reports on students, classes, teachers, and/or schools may comprise, but not be limited to, the following steps:
4050—compiling a plurality of test scores;
4100—analyzing the plurality of test scores,
   wherein analyzing the plurality of test scores comprises
      assigning each test score a letter grade, and
      assigning each test score a grade point average;
4150—creating at least one report,
   wherein the at least one report comprises refining data on the plurality of test scores; and
4200—transmitting the plurality of test scores to at least one third party database.

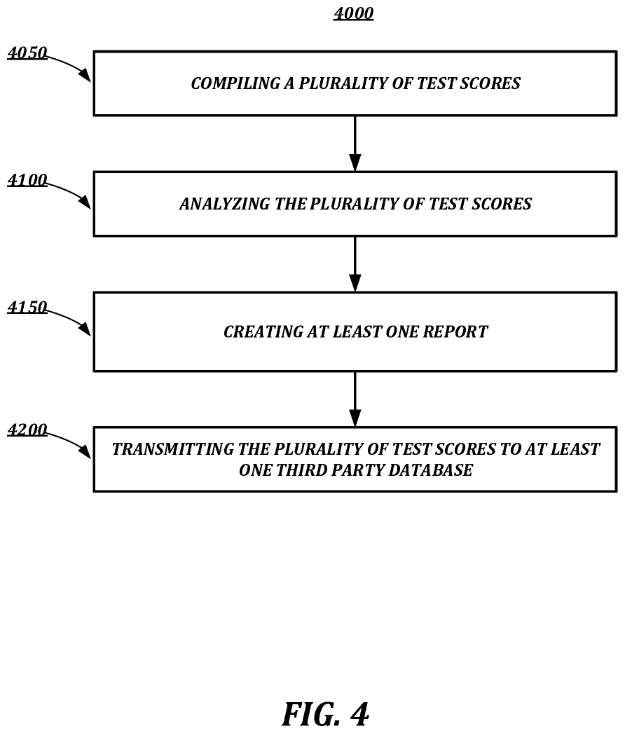

A flow chart setting forth the general stages involved in the method 4000 consistent with an embodiment of the disclosure for providing reports on students, classes, teachers, and/or schools may be provided. Any disclosed method may be implemented using a computing device 200 or any other component associated with platform 100 as described in more detail below with respect to FIG. 4. For illustrative purposes alone, computing device 200 is described as one potential actor in the any of the stages.

C. Method for Monitoring Student Activity

Consistent with embodiments of the present disclosure, a method 5000 may be performed by at least one of the aforementioned modules. The method 5000 may be embodied as, for example, but not limited to, computer instructions, which when executed, perform the method 5000. The method 5000 for monitoring student activity may comprise, but not be limited to, the following steps:
5050—recording keystrokes of a computing device;
   tracking at least one copying command of the computing device;
   tracking at least one pasting command of the computing device;
5100—analyzing an embedded information in the at least one pasting command; and
5150—notifying an administrator of the embedded information,
   wherein the embedded information is plagiarized.

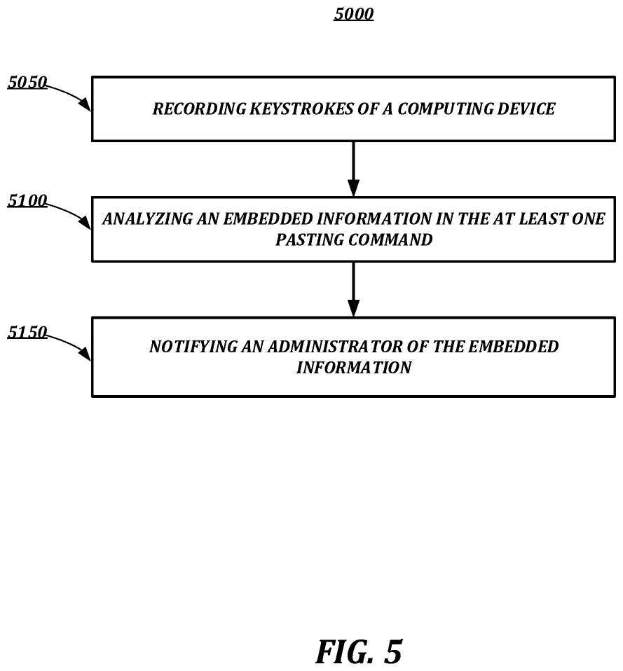

A flow chart setting forth the general stages involved in the method 5000 consistent with an embodiment of the disclosure for providing reports on students, classes, teachers, and/or schools may be provided. Any disclosed method may be implemented using a computing device 200 or any other component associated with platform 100 as described in more detail below with respect to FIG. 5. For illustrative purposes alone, computing device 200 is described as one potential actor in the any of the stages.

D. Method for Administering Testing

Consistent with embodiments of the present disclosure, a method 6000 may be performed by at least one of the aforementioned modules. The method 6000 may be embodied as, for example, but not limited to, computer instructions, which when executed, perform the method 6000. The method 6000 for administering testing may comprise, but not be limited to, the following steps:
6050—providing at least one testing material,
   wherein the at least one testing material is retrieved from a database;
6100—requesting an identification from a user,
   wherein the identification is at least one user biometric information;
6150—tracking a student hardware device,
   wherein tracking a student hardware device comprises:
      compiling at least one location of a plurality of student hardware devices, and
      recording keystrokes of at least one student input module;
6200—scanning the at least one predetermined testing material; and
6250—grading the at least one predetermined testing material.

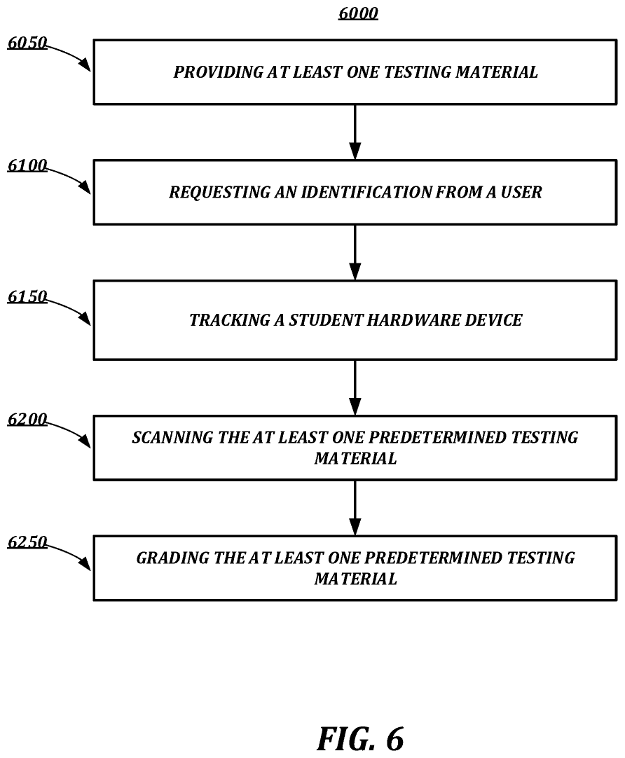

A flow chart setting forth the general stages involved in the method 6000 consistent with an embodiment of the disclosure for providing reports on students, classes, teachers, and/or schools may be provided. Any disclosed method may be implemented using a computing device 200 or any other component associated with platform 100 as described in more detail below with respect to FIG. 6. For illustrative purposes alone, computing device 200 is described as one potential actor in the any of the stages.

E. Method for Tracking Student Attention

Consistent with embodiments of the present disclosure, a method 7000 may be performed by at least one of the aforementioned modules. The method 7000 may be embodied as, for example, but not limited to, computer instructions, which when executed, perform the method 7000. The method for tracking student attention may comprise, but not be limited to, the following steps:
7050—determining a level of distraction of a user,
   wherein the level of distraction of a user is calculated my monitoring at least one eye movement and at least one face movement;
7100—alerting an administrator of a user's distraction; and
7150—alerting the user of their distraction,
   wherein the administrator pushes the alert to the user.

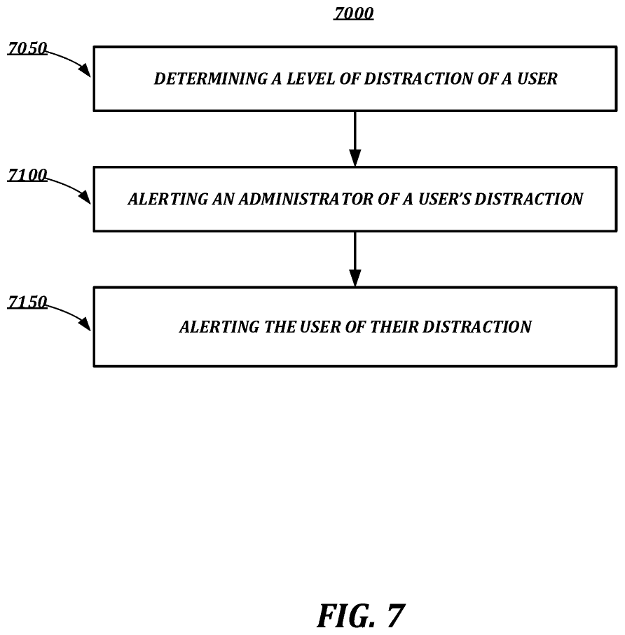

A flow chart setting forth the general stages involved in the method 700 consistent with an embodiment of the disclosure for providing reports on students, classes, teachers, and/or schools may be provided. Any disclosed method may be implemented using a computing device 200 or any other component associated with platform 100 as described in more detail below with respect to FIG. 7. For illustrative purposes alone, computing device 200 is described as one potential actor in the any of the stages.

F. Method of Facilitating a Virtual Lecture

Consistent with embodiments of the present disclosure, a method 8000 may be performed by at least one of the aforementioned modules. The method 8000 may be embodied as, for example, but not limited to, computer instructions, which when executed, perform the method 8000. The method for facilitating a lecture may comprise, but not be limited to, the following steps:
8050—providing a digital teaching lesson plan template,
   wherein the digital teaching lesson plan template is retrieved from a database;
8100—filling out the digital teaching lesson plan template by an administrator;
8150—providing a complete digital teaching lesson plan;
8200—transmitting the complete digital teaching lesson plan to at least one user; and
8250—mirroring the complete digital teaching lesson plan on at least one device of the at least one user and at least one device of the administrator,
   wherein the administrator controls the progression of the complete digital lesson plan.

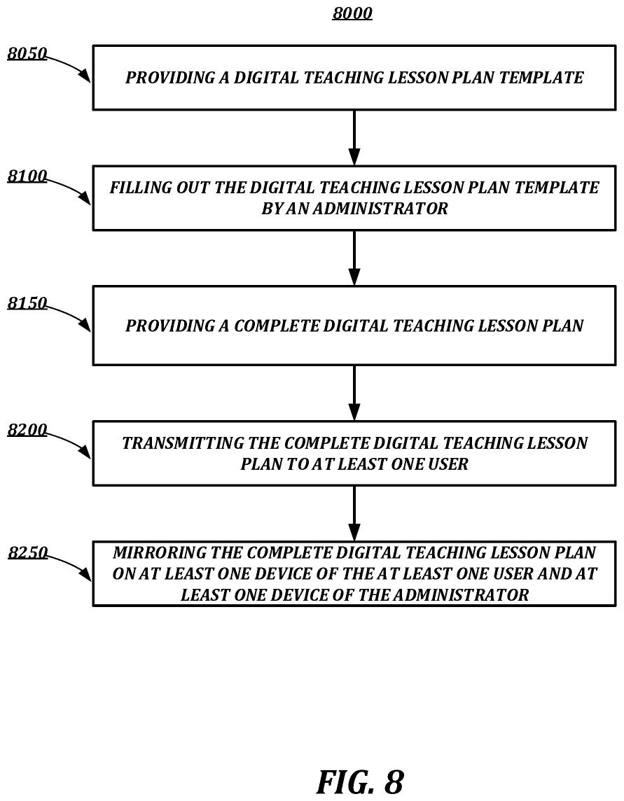

A flow chart setting forth the general stages involved in the method 8000 consistent with an embodiment of the disclosure for providing reports on students, classes, teachers, and/or schools may be provided. Any disclosed method may be implemented using a computing device 200 or any other component associated with platform 100 as described in more detail below with respect to FIG. 8. For illustrative purposes alone, computing device 200 is described as one potential actor in the any of the stages.

G. Method of Limiting Device Data Collection

A method for limiting device data collection may comprise, but not be limited to, the following steps:
9050—providing a plurality of data collection features of a device of a user;
9100—accessing the plurality of data collection features from a remote device,
   wherein the accessing the plurality of data collection features from a remote device comprises requiring unique credential information input; and
9150—limiting the plurality of data collection features from a remote device,
   wherein limiting the plurality of data collection features comprises reducing the amount of data collection from the device.

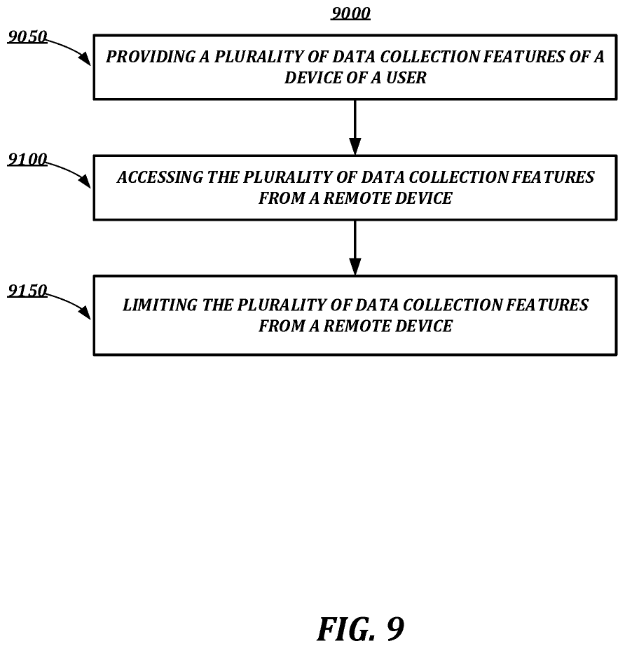

A flow chart setting forth the general stages involved in the method 9000 consistent with an embodiment of the disclosure for providing reports on students, classes, teachers, and/or schools may be provided. Any disclosed method may be implemented using a computing device 200 or any other component associated with platform 100 as described in more detail below with respect to FIG. 9. For illustrative purposes alone, computing device 200 is described as one potential actor in the any of the stages.

Embodiments of the present disclosure provide a hardware and software platform operative as a distributed system of modules and computing elements.

IV. Computing Device Architecture

Platform 100 may be embodied as, for example, but not be limited to, a website, a web application, a desktop application, backend application, and a mobile application compatible with a computing device 200. The computing device 200 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device;

Platform 100 may be hosted on a centralized server or a cloud computing service. Although a plurality of methods have been described to be performed by a computing device 200, it should be understood that, in some embodiments, different operations may be performed by a plurality of the computing devices 200 in operative communication at least one network.

Embodiments of the present disclosure may comprise a system having a central processing unit (CPU) 220, a bus 230, a memory unit 240, a power supply unit (PSU) 250, and one or more Input/Output (I/O) units. The CPU 220 coupled to the memory unit 240 and the plurality of I/O units 260 via the bus 230, all of which are powered by the PSU 250. It should be understood that, in some embodiments, each disclosed unit may actually be a plurality of such units for the purposes of redundancy, high availability, and/or performance. The combination of the presently disclosed units is configured to perform the stages any method disclosed herein.

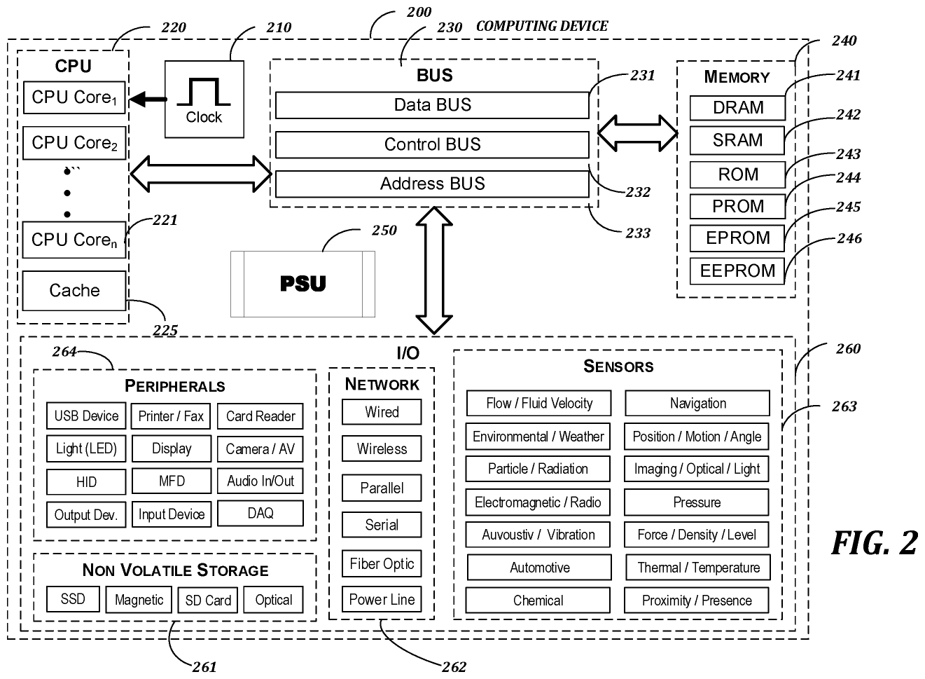

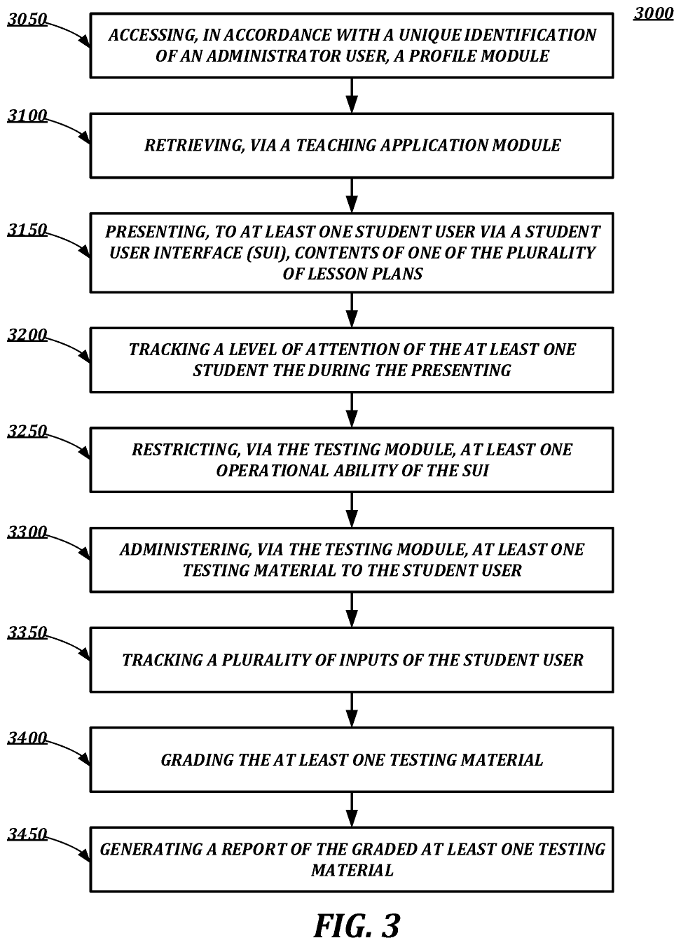

FIG. 2 is a block diagram of a system including computing device 200. Consistent with an embodiment of the disclosure, the aforementioned CPU 220, the bus 230, the memory unit 240, a PSU 250, and the plurality of I/O units 260 may be implemented in a computing device, such as computing device 200 of FIG. 2. Any suitable combination of hardware, software, or firmware may be used to implement the aforementioned units. For example, the CPU 220, the bus 230, and the memory unit 240 may be implemented with computing device 200 or any of other computing devices 200, in combination with computing device 200. The aforementioned system, device, and components are examples and other systems, devices, and components may comprise the aforementioned CPU 220, the bus 230, the memory unit 240, consistent with embodiments of the disclosure.

At least one computing device 200 may be embodied as any of the computing elements illustrated in all of the attached figures, including [list the modules and methods]. A computing device 200 does not need to be electronic, nor even have a CPU 220, nor bus 230, nor memory unit 240. The definition of the computing device 200 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 200, especially if the processing is purposeful.

With reference to FIG. 2, a system consistent with an embodiment of the disclosure may include a computing device, such as computing device 200. In a basic configuration, computing device 200 may include at least one clock module 210, at least one CPU 220, at least one bus 230, and at least one memory unit 240, at least one PSU 250, and at least one I/O 260 module, wherein I/O module may be comprised of, but not limited to a non-volatile storage sub-module 261, a communication sub-module 262, a sensors sub-module 263, and a peripherals sub-module 264.

A system consistent with an embodiment of the disclosure the computing device 200 may include the clock module 210 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 220, the central component of modern computers, which relies on a clock. The only exceptions are asynchronous circuits such as asynchronous CPUs. The clock 210 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 200 use a “clock multiplier” which multiplies a lower frequency external clock to the appropriate clock rate of the CPU 220. This allows the CPU 220 to operate at a much higher frequency than the rest of the computer, which affords performance gains in situations where the CPU 220 does not need to wait on an external factor (like memory 240 or input/output 260). Some embodiments of the clock 210 may include dynamic frequency change, where, the time between clock edges can vary widely from one edge to the next and back again.

A system consistent with an embodiment of the disclosure the computing device 200 may include the CPU unit 220 comprising at least one CPU Core 221. A plurality of CPU cores 221 may comprise identical the CPU cores 221, such as, but not limited to, homogeneous multi-core systems. It is also possible for the plurality of CPU cores 221 to comprise different the CPU cores 221, such as, but not limited to, heterogeneous multi-core systems, big.LITTLE systems and some AMD accelerated processing units (APU). The CPU unit 220 reads and executes program instructions which may be used across many application domains, for example, but not limited to, general purpose computing, embedded computing, network computing, digital signal processing (DSP), and graphics processing (GPU). The CPU unit 220 may run multiple instructions on separate CPU cores 221 at the same time. The CPU unit 220 may be integrated into at least one of a single integrated circuit die and multiple dies in a single chip package. The single integrated circuit die and multiple dies in a single chip package may contain a plurality of other aspects of the computing device 200, for example, but not limited to, the clock 210, the CPU 220, the bus 230, the memory 240, and I/O 260.

The CPU unit 220 may contain cache 222 such as, but not limited to, a level 1 cache, level 2 cache, level 3 cache or combination thereof. The aforementioned cache 222 may or may not be shared amongst a plurality of CPU cores 221. The cache 222 sharing comprises at least one of message passing and inter-core communication methods may be used for the at least one CPU Core 221 to communicate with the cache 222. The inter-core communication methods may comprise, but not limited to, bus, ring, two-dimensional mesh, and crossbar. The aforementioned CPU unit 220 may employ symmetric multiprocessing (SMP) design.

The plurality of the aforementioned CPU cores 221 may comprise soft microprocessor cores on a single field programmable gate array (FPGA), such as semiconductor intellectual property cores (IP Core). The plurality of CPU cores 221 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 221, for example, but not limited to Instruction-level parallelism (ILP) such as, but not limited to, superscalar pipelining, and Thread-level parallelism (TLP).

Consistent with the embodiments of the present disclosure, the aforementioned computing device 200 may employ a communication system that transfers data between components inside the aforementioned computing device 200, and/or the plurality of computing devices 200. The aforementioned communication system will be known to a person having ordinary skill in the art as a bus 230. The bus 230 may embody internal and/or external plurality of hardware and software components, for example, but not limited to a wire, optical fiber, communication protocols, and any physical arrangement that provides the same logical function as a parallel electrical bus. The bus 230 may comprise at least one of, but not limited to a parallel bus, wherein the parallel bus carry data words in parallel on multiple wires, and a serial bus, wherein the serial bus carry data in bit-serial form. The bus 230 may embody a plurality of topologies, for example, but not limited to, a multidrop/electrical parallel topology, a daisy chain topology, and a connected by switched hubs, such as USB bus. The bus 230 may comprise a plurality of embodiments, for example, but not limited to
Internal data bus (data bus) 231/Memory bus
Control bus 232
Address bus 233
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (i.g. PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g. PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 200 may employ hardware integrated circuits that store information for immediate use in the computing device 200, know to the person having ordinary skill in the art as primary storage or memory 240. The memory 240 operates at high speed, distinguishing it from the non-volatile storage sub-module 261, which may be referred to as secondary or tertiary storage, which provides slow-to-access information but offers higher capacities at lower cost. The contents contained in memory 240, may be transferred to secondary storage via techniques such as, but not limited to, virtual memory and swap. The memory 240 may be associated with addressable semiconductor memory, such as integrated circuits consisting of silicon-based transistors, used for example as primary storage but also other purposes in the computing device 200. The memory 240 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 241, Static Random-Access Memory (SRAM) 242, CPU Cache memory 225, Advanced Random-Access Memory (A-RAM), and other types of primary storage such as Random-Access Memory (RAM).
Non-volatile memory which can retain stored information even after power is removed, for example, but not limited to, Read-Only Memory (ROM) 243, Programmable ROM (PROM) 244, Erasable PROM (EPROM) 245, Electrically Erasable PROM (EEPROM) 246 (e.g. flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 200 may employ the communication system between an information processing system, such as the computing device 200, and the outside world, for example, but not limited to, human, environment, and another computing device 200. The aforementioned communication system will be known to a person having ordinary skill in the art as I/O 260. The I/O module 260 regulates a plurality of inputs and outputs with regard to the computing device 200, wherein the inputs are a plurality of signals and data received by the computing device 200, and the outputs are the plurality of signals and data sent from the computing device 200. The I/O module 260 interfaces a plurality of hardware, such as, but not limited to, non-volatile storage 261, communication devices 262, sensors 263, and peripherals 264. The plurality of hardware is used by the at least one of, but not limited to, human, environment, and another computing device 200 to communicate with the present computing device 200. The I/O module 260 may comprise a plurality of forms, for example, but not limited to channel I/O, port mapped I/O, asynchronous I/O, and Direct Memory Access (DMA).

Consistent with the embodiments of the present disclosure, the aforementioned computing device 200 may employ the non-volatile storage sub-module 261, which may be referred to by a person having ordinary skill in the art as one of secondary storage, external memory, tertiary storage, off-line storage, and auxiliary storage. The non-volatile storage sub-module 261 may not be accessed directly by the CPU 220 without using intermediate area in the memory 240. The non-volatile storage sub-module 261 does not lose data when power is removed and may be two orders of magnitude less costly than storage used in memory module, at the expense of speed and latency. The non-volatile storage sub-module 261 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (261) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO)
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor
Magnetic storage such as, but not limited to, Hard Disk Drive (HDD), tape drive, carousel memory, and Card Random-Access Memory (CRAM)
Phase-change memory
Holographic data storage such as Holographic Versatile Disk (HVD)
Molecular Memory
Deoxyribonucleic Acid (DNA) digital data storage

Consistent with the embodiments of the present disclosure, the aforementioned computing device 200 may employ the communication sub-module 262 as a subset of the I/O 260, which may be referred to by a person having ordinary skill in the art as at least one of, but not limited to, computer network, data network, and network. The network allows computing devices 200 to exchange data using connections, which may be known to a person having ordinary skill in the art as data links, between network nodes. The nodes comprise network computer devices 200 that originate, route, and terminate data. The nodes are identified by network addresses and can include a plurality of hosts consistent with the embodiments of a computing device 200. The aforementioned embodiments include, but not limited to personal computers, phones, servers, drones, and networking devices such as, but not limited to, hubs, switches, routers, modems, and firewalls.

Two nodes can be said are networked together, when one computing device 200 is able to exchange information with the other computing device 200, whether or not they have a direct connection with each other. The communication sub-module 262 supports a plurality of applications and services, such as, but not limited to World Wide Web (WWW), digital video and audio, shared use of application and storage computing devices 200, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g. TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g. Global System for Mobile Communications [GSM], General Packet Radio Service [GPRS], Code-Division Multiple Access [CDMA], and Integrated Digital Enhanced Network [IDEN]).

The communication sub-module 262 may comprise a plurality of size, topology, traffic control mechanism and organizational intent. The communication sub-module 262 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength)
Parallel communications, such as, but not limited to, LPT ports.
Serial communications, such as, but not limited to, RS-232 and USB
Fiber Optic communications, such as, but not limited to, Single-mode optical fiber (SMF) and Multi-mode optical fiber (MMF)
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 200 may employ the sensors sub-module 263 as a subset of the I/O 260. The sensors sub-module 263 comprises at least one of the devices, modules, and subsystems whose purpose is to detect events or changes in its environment and send the information to the computing device 200. Sensors are sensitive to the measured property, are not sensitive to any property not measured, but may be encountered in its application, and do not significantly influence the measured property. The sensors sub-module 263 may comprise a plurality of digital devices and analog devices, wherein if an analog device is used, an Analog to Digital (A-to-D) converter must be employed to interface the said device with the computing device 200. The sensors may be subject to a plurality of deviations that limit sensor accuracy. The sensors sub-module 263 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 200 may employ the peripherals sub-module 262 as a subset of the I/O 260. The peripheral sub-module 264 comprises ancillary devices uses to put information into and get information out of the computing device 200. There are 3 categories of devices comprising the peripheral sub-module 264, which exist based on their relationship with the computing device 200, input devices, output devices, and input/output devices. Input devices send at least one of data and instructions to the computing device 200. Input devices can be categorized based on, but not limited to:
Modality of input, such as, but not limited to, mechanical motion, audio, visual, and tactile
Whether the input is discrete, such as but not limited to, pressing a key, or continuous such as, but not limited to position of a mouse
The number of degrees of freedom involved, such as, but not limited to, two-dimensional mice vs three-dimensional mice used for Computer-Aided Design (CAD) applications

Output devices provide output from the computing device 200. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 264:
Input Devices
   Human Interface Devices (HID), such as, but not limited to, pointing device (e.g. mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 200. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 200 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data Acquisition (DAQ) devices covert at least one of analog signals and physical parameters to digital values for processing by the computing device 200. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking device (e.g. devices disclosed in network 262 sub-module), data storage device (non-volatile storage 261), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

V. Aspects

The following disclose various Aspects of the present disclosure. The various Aspects are not to be construed as patent claims unless the language of the Aspect appears as a patent claim. The Aspects describe various non-limiting embodiments of the present disclosure.

Aspect 1. Teachers can click on links in lesson plans from Master Tablet that go to curriculum/subject/page
Student tablets connect with master tablet and work in conjunction with lesson plan
Aspect 2. Master tablet has smaller window where teacher views what students are looking at on their screens
Aspect 3. Contact information for students and parent/guardians, any health alerts, and ability to input contact information into the application/software located on the admin app/software on master tablet
Aspect 4. Master Tablet is able to connect to and provide software and is able to review and load IEP's/SLP's, past grades of students up until current year on master tablet
Aspect 5. Documentation of daily behavior, documentation of extreme behavior, and ability to immediately email to student parent/guardian/proper school staff
Aspect 6. 1st Use—Combines all teacher needs in one software system with easy to use applications and system processes.
Aspect 7. 2nd Use—Master Teacher Tablet has software that connects to all student software and can monitor, disseminate, test, set pacing, goal setting, testing, and more for the students. This software takes the place of the teachers need to:
1. Remember daily goals, lesson plan steps
2. Get distracted by focusing on one or two students in which the remaining students wait to move forward based on the older teacher model
3. Increases teachers ability to multi-task faster and with much more ease
4. Lessens the need to mentally remember each item on the agenda (software has recorded the information and is accessible to the teacher at any time)
5. Enables the teacher to monitor each individual student tablet, wherever the master tablet is located
6. Student tablet software has a built in online tutor or “helper” which students can access prior to needing teacher intervention. This creates a more independent student and reduces frustration or delays for students who no longer need to wait on teacher explanation to move forward with assignment
7. Reduces loss of paperwork, information. The software automatically records and retains information students input or teachers input
   Aspect 8. Even the novel teacher can easily understand and use this software with proper training or following the instruction manual. The tablet has a keyboard option for dexterity in use for inputting information quickly.
   Aspect 9. The software in the master tablet contains twofold use for the teacher. The first use is administrator software located in one place, the master tablet software. The second use is to teach students. This portion of the tech uses a master tablet that contains specialized software connected to their student tablets.
   Aspect 10. The Master tablet software has administrator and teaching applications that include: lesson plans, scheduler/calendar, curriculum for all subjects, statewide standards, benchmark tests, quizzes, statewide exams, Common core, state and national academic standards for all grade levels, etc. Can/may include tech for Professors.
   Aspect 11. Currently, teachers are often bombarded with a need to multi task. This multi tasking includes: devising lesson plans, grading papers, disseminating tasks to a class, then individualizing tasks to individual students simultaneously, filling out paperwork, contacting parents, recording information on different software systems designed by school, monitoring student behavior and progress in a given classroom setting, reporting to administration, disciplinary action of said students, improving standardized test scores, analyzing data, and more. Teacher's tasks are often separated by each task and extremely time consuming. Also, teacher tasks are generally completed on paper. Curriculum and software systems are in multiple places which can be extraordinarily time consuming and complex. This, in effect, can burn teachers out. Teachers focus more on entering information on multiple softwares, paperwork and other items, finding papers, books, and inputting test scores. This distracts them from being able to focus on the most important task: the student learning.
   Aspect 12. This software (Tech and Teach) is twofold in its usefulness to teachers/instructors. The first use is that it combines all teacher needs in one software system with easy to use applications and system processes. The second, is that the master Teacher Tablet has software that connects to all student software and can in effect monitor, disseminate, test, set pacing, goal setting, testing, and more for the students. This software takes the place of the teachers need to: 1. Remember all daily goals, lesson plan steps. 2. Get distracted by focusing on one or two students in which the remaining students wait to move forward based on the older teacher model. 3.
   Aspect 13. Increases teachers ability to multi task faster and with much more easy. 4. Lessens the need to mentally remember each item on the agenda (the software has recorded the information and is accessible to the teacher at anytime). 5. Enables the teacher to monitor each individual student tablet, wherever the master tablet is located. 6. Student tablet software has a built in online tutor or “helper” which student can access prior to needing teacher intervention. This creates a more independent student and reduces frustration or delays for students who no longer need to wait on teacher explanation to move forward with assignment 7. Reduces loss of paperwork, information. The software automatically records and retains information students input or teachers input.
   Aspect 14. Overall, the software program advances the teaching industry using technology. The tech creates a more independent student learner who also learns how to use tech in a student format while reducing excess paperwork, time, and superfluous tasks by the teacher.
   Aspect 15. The software is loaded unto the master tablet and student tablets. Software establishes teaching software for administrative work in the form of various applications on the master tablet. Software has an application for testing, grading. Software has an application that monitors, controls, and can download information, curriculum, student reporting to student tablet software. Software is included on the student tablet that connects to the master software. The tablets can connect using the following tech: Wifi, wiring, cloud, or servers that connects the student tablets and master tablets in order to share information. Software has sufficient memory to hold all information. Software has several options for storage and memory. Software is connected to server, cloud, has a hard drive that can be connected to dump files into as well.
   Aspect 16. The master tablet is two part. It has software that is solely administrative for teacher use. Then, the master tablet has teaching and/or curriculum software that directly connects to all student tablets. The master tablet software links to student tablet software and can control, monitor, link, connect, and view the student tablet(s).

### Aspect 17. Master Tablet and Student Tablets

Pre Loaded Lesson plan templates (all subjects and grades)
Pre Loaded Complete lesson plans
Pre Loaded Lesson Plans (templates or completed plans) with national common core standards and state standards for each grade and subject. Teacher can click on subject, grade, and choose from the list of standards while devising lesson plans.
Pre Loaded curriculum
Set lesson plans automatically for substitute teachers on tablet with option to email principal, or school staff the automated lesson plans.

### Aspect 18. Use of Master and Student Tablet (Interconnectivity)

1. Teachers can also click on links in lesson plans from Master Tablet that go straight to curriculum/subject/page.
2. Student tablets connect with master tablet and work in conjunction with Lesson Plan. For example, master tablet shows lesson plan to work on vocabulary words. Link in lesson plan on master tablet to set all student tablets to show vocabulary words.
3. Master tablet has smaller window where teacher views what students are looking at on their screens. Master tablet can view what each student tablet is viewing at the present moment with a click on student tablet #(1-30 or depending on amount of students).
4. All contact information for all students and student parent/guardians, any important health alerts, and the ability to input contact information into the application/software are located on the admin app/software on master tablet.
5. Master Tablet is able to connect to and provide software and is able to review and load IEP's/SLP's, past grades of students up until current year on master tablet.
6. Master tablet software is able to complete IEP's/SLP's of students from server, cloud, or form. Password and access code for confidentiality. Past, present, attendance review and recorder
7. Documentation of daily behavior, documentation of extreme behavior (good or bad) and the ability to immediately email to student parent/guardian/proper school staff via email, cloud, or school server.
8. Notification of warnings of failing grades/tests/quizzes and option to immediately send info to parents via email, cloud or school server.
9. Based on student input from quizzes, lessons, benchmarks, tests, on student tablets, Master Tablet is designed to automatically generate scores on student quizzes, performance, benchmarks and tests. These scores can be automatically sent to teacher, principal, parent, etc. via email, cloud or server. Scores can be automatically compared to national, state and local scores to assess students comprehension and grade level competency. (The purpose is to reduce paperwork and time it takes to understand whether students can pass or fail state exam quickly. Which enables the teacher and school to rectify any issues swiftly).
10. All Scores (daily lessons, quizzes, tests, etc) inputted by student on student tablet can be generated and averaged to give computational average of assignments over the course of the semester. Teacher must be able to adjust and add or subtract from score. With teacher reasoning in notation. There will also be a response section for teacher to notate student progress positive or negative.
11. Automatic progress reports generated with grade. Teacher can approve reports be sent to parent, principal or school staff via email, server or cloud. Confirmation receipt by parent required by teacher.
12. Cooperative/paired learning. Students can work collectively on a project using 1 student tablet or each student tablet.
13. Student class scores on unit exams are automatically processed and compared to national, state and local standards so teachers, school staff, districts, can accurately assess students proficiency in classroom.
14. Teacher can use master tablet to set the unit, unit exam, worksheets so all student tablets produce teacher directed assignment. Example, teacher types in/clicks on Master Tablet: Unit 2, Page 41. All student tablets automatically pull up Unit 2, page 41. Teacher types in or taps: Unit 2 Exam and all students tablets turn to Unit 2 exam.
15. There will also be an option for teacher to click on each student tablet assigned to give autonomy to the student tablet. So a student tablet can read or review on his/her own at his/her own pace. The master tablet has the ability to control all tablets or release each student tablet to an autonomous state.
16. Timer. Teacher can assign a timer to each students work for testing, class, etc. Or separate timer can be on Teachers tablet to ensure they are keeping on task for lesson. Each student tablet also includes a timer so students can keep track of time. Timer will automatically come on, however, timer can be set on or off by teacher. Timer will turn red during the last 5 minutes of assignment.
17. Lesson plans loaded on master tablet will contain a checklist. When teacher finishes each section of the lesson plan, teacher clicks ‘check’ and the lesson plan moves to next phase. So teacher doesn't have to remember where they left off or remember what they need to do next. Timer will be set on lesson plans as well for each section. However, timer can be turned off if teacher so chooses.
18. Lesson plan templates can be independently completed by teacher, or generic lesson plan templates are already completed and ready for teacher use. Substitute lesson plans are also available and easy to set up on master tablet. Lesson plans have the option of being printed for substitute teacher and students, or can remain on Master Tablet and student tablets. Teacher can set the option of enabling other teachers to use or not to use master tablet.
19. Master tablet can set up a “ding” to notify teacher which students are lagging behind on lesson, and highlight students who are moving significantly slower than other students on work. Example: if most students are on page 34 and one student is on page 31, Master tablet will notify teacher. Master tablet can “read” each student tablets progress. Or if most students are on question 25 and one student tablet “reads” another student on question 10, a notification will be sent to Master Tablet.
20. Master tablet sets up class profile for each teacher with student name/info/parent info, doctor info, etc.
11. Automatic progress reports generated with grade. Teacher can approve reports be sent to parent, principal or school staff via email, server or cloud. Confirmation receipt by parent required by teacher.
12. Cooperative/paired learning. Students can work collectively on a project using 1 student tablet or each student tablet.
13. Student class scores on unit exams are automatically processed and compared to national, state and local standards so teachers, school staff, districts, can accurately assess students proficiency in classroom.
14. Teacher can use master tablet to set the unit, unit exam, worksheets so all student tablets produce teacher directed assignment. Example, teacher types in/clicks on Master Tablet: Unit 2, Page 41. All student tablets automatically pull up Unit 2, page 41. Teacher types in or taps: Unit 2 Exam and all students tablets turn to Unit 2 exam.
15. There will also be an option for teacher to click on each student tablet assigned to give autonomy to the student tablet. So a student tablet can read or review on his/her own at his/her own pace. The master tablet has the ability to control all tablets or release each student tablet to an autonomous state.
16. Timer. Teacher can assign a timer to each students work for testing, class, etc. Or separate timer can be on Teachers tablet to ensure they are keeping on task for lesson. Each student tablet also includes a timer so students can keep track of time. Timer will automatically come on, however, timer can be set on or off by teacher. Timer will turn red during the last 5 minutes of assignment.
17. Lesson plans loaded on master tablet will contain a checklist. When teacher finishes each section of the lesson plan, teacher clicks ‘check’ and the lesson plan moves to next phase. So teacher doesn't have to remember where they left off or remember what they need to do next. Timer will be set on lesson plans as well for each section. However, timer can be turned off if teacher so chooses.
18. Lesson plan templates can be independently completed by teacher, or generic lesson plan templates are already completed and ready for teacher use. Substitute lesson plans are also available and easy to set up on master tablet. Lesson plans have the option of being printed for substitute teacher and students, or can remain on Master Tablet and student tablets. Teacher can set the option of enabling other teachers to use or not to use master tablet.
19. Master tablet can set up a “ding” to notify teacher which students are lagging behind on lesson, and highlight students who are moving significantly slower than other students on work. Example: if most students are on page 34 and one student is on page 31, Master tablet will notify teacher. Master tablet can “read” each student tablets progess. Or if most students are on question 25 and one student tablet “reads” another student on question 10, a notification will be sent to Master Tablet.
20. Master tablet sets up class profile for each teacher with student name/info/parent info, doctor info, etc.

### Aspect 19. Student Tablets:

1. Student tablets have a helper tutor to help students virtually on subject or area they are working on.
2. All tablets (student and Master) will have headphone services that will enable students to work independently and privately.
3. Tablet may have Bluetooth capabilities that will connect each tablet or additional wifi tech or tech that connects all student tablets to master tablet.
4. Student tablets can connect with other student tablets to work in groups and/or cooperative learning sessions.
5. Student Tablets have a click button to alert teachers that student needs assistance.
6. Student tablets are all connected and ultimately controlled by Master tablet. However, the master tablet can enable student tablets to be independent tablets or work with other students for cooperative learning.
7. Student tablets possess software that enables access to curriculum, student work, academic work, and work assigned by teacher/instructor through master tablet.
8. Students can send messages from student tablet to teacher or to Master Tablet to communicate regarding work. Master tablet can send messages to student tablet. All correspondence will be recorded and can be accessed by administration.
9. Tablets will all have restrictions on any word uses that are improper sexually, or gratuitous in language.
10. Student tablets are interconnected to one another and can communicate with one another if Master Tablet sets the settings to connect student tablets together to work on/edit/adjust documents, images, graphics, Math, spreadsheets, testing, quizzes, school work, or any other items that students choose to work together on.
11. Students can click to see one another's screens and can both enter in answers, or questions, or write information on a screen that is mutually shared by multiple students.
Aspect 20. A method for grading test scores, the method comprising:
compiling a plurality of test scores;
analyzing the plurality of test scores,
   wherein analyzing the plurality of test scores comprises
      assigning each test score a letter grade, and
      assigning each test score a grade point average;
   creating at least one report,
      wherein the at least one report comprises refining data on the plurality of test scores; and transmitting the plurality of test scores to at least one third party database.
      Aspect 21. A method for monitoring student activity, the method comprising:
recording keystrokes of a computing device;
tracking at least one copying command of the computing device;
tracking at least one pasting command of the computing device;
analyzing an embedded information in the at least one pasting command; and
notifying an administrator of the embedded information,
   wherein the embedded information is plagiarized.
   Aspect 22. A method for administering testing, the method comprising:
providing at least one testing material,
   wherein the at least one testing material is retrieved from a database;
requesting an identification from a user,
   wherein the identification is at least one user biometric information;
tracking a student hardware device,
   wherein tracking a student hardware device comprises:
compiling at least one location of a plurality of student hardware devices, and
recording keystrokes of at least one keyboard module;
scanning the at least one predetermined testing material; and
grading the at least one predetermined testing material.
   Aspect 23. A method of tracking student attention, the method comprising.
determining a level of distraction of a user,
wherein the level of distraction of a user is calculated my monitoring at least one eye movement and at least one face movement;
alerting an administrator of a user's distraction; and
alerting the user of their distraction,
wherein the administrator pushes the alert to the user.
   Aspect 24. A method of facilitating a virtual lecture, the method comprising:
providing a digital teaching lesson plan template,
wherein the digital teaching lesson plan template is retrieved from a database;
filling out the digital teaching lesson plan template by an administrator;
providing a complete digital teaching lesson plan;
transmitting the complete digital teaching lesson plan to at least one user; and
mirroring the complete digital teaching lesson plan on at least one device of the at least one user and at least one device of the administrator,
wherein the administrator controls the progression of the complete digital lesson plan.
   Aspect 25. A limiting device data collection, the method comprising:
providing a plurality of data collection features of a device of a user;
accessing the plurality of data collection features from a remote device,
wherein the accessing the plurality of data collection features from a remote device comprises requiring unique credential information input; and
limiting the plurality of data collection features from a remote device,
wherein limiting the plurality of data collection features comprises reducing the amount of data collection from the device.
   Aspect 26. The platform of any preceding aspect, wherein the plurality of statewide standards comprises a plurality of government regulated educational standards and mandates.
   Aspect 27. The platform of any preceding aspect, wherein the AI teacher module is configured to learn via monitoring the actions of the administrator user.
   Aspect 28. The platform of any preceding aspect, wherein the AI teacher module is configured to progress the curriculum in accordance with the learning.
   Aspect 29. The platform of any preceding aspect, wherein the testing module is configured to restrict operation of at least a part of the AUI by the student.
   Aspect 30. The platform of any preceding aspect, wherein the testing module is configured to provide to the student user at least one of the following:
   at least one test;
   at least one quiz; and
   at least one assignment.
   Aspect 31. The platform of any preceding aspect, wherein the student hardware module is configured to receive an input from at least one external hardware element.
   Aspect 32. The platform of any preceding aspect, wherein the external hardware element comprises at least one of the following:
   a keyboard;
   a touchscreen;
   a mouse; and
   a stylus.

VI. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A system comprising:
an administrator hardware module comprising an memory storage coupled to a hardware processor, the hardware processor comprising an Administrator User Interface (AUI) configured to allow an administrator user to operate the following:
a profile module configured to perform the following:
retrieve information relating to one or more administrator profile, and
retrieve information relating to one or more class profile,
a teaching application module comprising:
a curriculum,
a testing module, and
a scheduler,
a student hardware operative connectivity module configured to perform the following:
provide operative communication between the administrator hardware module and a student hardware module,
transmit, to the student hardware module, one or more of the following:
at least a portion of the curriculum,
a learning material,
a study material, and
a testing material, and
receive, from the student hardware module, one or more of the following:
a response to the testing material,
an indication of progress through the curriculum, and
a message for the administrator user; and
an artificial intelligence (“AI”) teacher module configured to operate the AUI upon an absence of the administrator user.

2. The system of claim 1, wherein the one or more class profile comprises the following:
a listing of personal information at least one student user;
saved content specific to a class; and
saved content specific to the at least one student user.

3. The system of claim 1, wherein the student hardware operative connectivity module is configured to allow the administrator user to view a Student User Interface (SUI).

4. The system of claim 3, wherein the student hardware operative connectivity module is configured to control operations of the student hardware module.

5. The system of claim 1, wherein the curriculum comprises:
one or more lesson plan;
one or more lesson plan template; and
a plurality of statewide standards.

6. The system of claim 5, wherein the student hardware operative connectivity module is configured to provide a notification to the administrator user upon at least one student user deviating from a projected pace of the one or more lesson plan.

7. The system of claim 1, wherein the student hardware operative connectivity module further comprises a language monitor module configured to, via Natural Language Processing (NLP), prevent a plurality of predetermined words to be submitted by at least one student user.

8. (canceled)

9. The system of claim 1, wherein the student hardware operative connectivity module further comprises a parental controls module configured to operatively communicate with a device of a guardian of at least one student user allowing the guardian of the at least one student user to control a plurality of privacy options of the at least one student user.

10. (canceled)

11. The system of claim 1, wherein the student hardware module comprises:
a student-facing memory storage coupled to a student-facing processing unit, the student-facing processing unit comprising a Student User Interface (SUI) configured to allow at least one student user to operate the following:
a learning application module configured to receive the following via the administrator hardware module:
a plurality of learning materials,
a plurality of study materials, and
a plurality of testing materials,
a virtual tutor module configured for virtual tutoring of the at least one student user; and
a communications module configured to allow communication between the at least one student user and the administrator user.

12. The system of claim 1, further comprising an administrator calendar, the administrator calendar being configured to be in operative communication with the scheduler.

13. The system of claim 12, wherein the scheduler is configured to allow at least one of a student user and a guardian of the student user to schedule at least one appointment with the administrator user in accordance with the administrator calendar.

14. The system of claim 5, wherein the student hardware operative connectivity module is configured detect at least one student user deviating from a projected pace of the one or more lesson plan.

15. One or more non-transitory computer readable media comprising instructions which, when executed by one or more hardware processors, causes performance of operations comprising:
operatively connecting an administrator hardware module to at least one student hardware module;
operating, via an Administrator User Interface (AUI), the administrator hardware module, the operating comprising:
accessing, in accordance with a unique identification of an administrator user, a profile module, the profile module comprising:
at least one administrator profile,
at least one class profile,
retrieving, via a teaching application module, the following:
a curriculum comprising a plurality of lesson plans,
a testing module, and
a scheduler,
presenting, to at least one student user via a Student User Interface (SUI), contents of one of the plurality of lesson plans,
tracking a level of attention of the at least one student user the during the presenting,
restricting, via the testing module, at least one operational ability of the SUI,
administering, via the testing module, at least one testing material to the at least one student user, the at least one student user being operative to conduct the at least one testing material via the SUI,
tracking a plurality of inputs of the at least one student user,
grading, upon completion and submission of the at least one testing material by the at least one student user, the at least one testing material, and
generating a report of the graded at least one testing material.

16. The one or more non-transitory computer readable media of claim 15, wherein tracking the level of attention of the at least one student user the during the presenting comprises analyzing physical attributes and movements thereof of the at least one student user.

17. The one or more non-transitory computer readable media of claim 15, wherein determining a minimum level of attention threshold for the at least one student user during the presenting.

18. The one or more non-transitory computer readable media of claim 17 wherein transmitting a notification to the administrator hardware module upon the at least one student user moving below the minimum level of attention threshold.

19. The one or more non-transitory computer readable media of claim 15, wherein tracking the plurality of inputs of the at least one student user comprises receiving an input from at least one external hardware element, the external hardware element comprising at least one of the following:
a keyboard;
a touchscreen;
a mouse; and
a stylus.

20. (canceled)

21. A method for teaching via an Artificial Intelligence (AI) teacher module, the method comprising:
activating, by an administrator, the AI teacher module, the AI Teacher module being configured to retrieve information specific to the administrator using an Administrator User Interface (AUI), the information comprising one or more of the following:
teaching rate,
talking cadence,
one or more lesson plan, the one or more lesson plan comprising:
a plurality of teaching materials,
a plurality of testing materials, and
one or more assignment associated with the one or more lesson plan; and
executing, via the AI teacher module and without receiving input from the administrator, the one or more lesson plan, the executing comprising:
accessing the one or more lesson plan,
processing, the one or more lesson plan via at least one of the following:
Optical Character Recognition (OCR), and
Natural Language Processing (NLP),
presenting the processed one or more lesson plan to one or more student via a student hardware operative connectivity module, the presenting comprising:
transmitting, to the one or more student via the student hardware operative connectivity module, a portion of the processed one or more lesson plan,
receiving a plurality of metrics relating to each of the one or more student, the plurality of metrics comprising one or more of the following:
actions performed by the one or more student on a Student User Interface (SUI),
deviation from a projected pace of the one or more lesson plan,
accuracy of one or more of the following:
one or more of the plurality of testing materials, and
the one or more assignment associated with the one or more lesson plan, and
adjusting, in accordance with the received plurality of metrics, the one or more lesson plan.

22. The method of claim 21, further comprising restricting, in accordance with the received plurality of metrics, at least a portion of operativity of the SUI.

23. The method of claim 21, wherein receiving the plurality of metrics relating to each of the one or more student further comprises receiving data from one or more external hardware element in operative communication with the SUI.
